(19) United States
(12) Patent Application Publication
(10) Pub. No.: US 2008/0278267 A1
(43) Pub. Date: Nov. 13, 2008

(54) Large Diameter Rf Rotary Coupler

(76) Inventors: John Peter Beckley, Oxfordshire (GB); Victor Alexandrovich Kalinin, Oxfordshire (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/885,813

(22) PCT Filed: Feb. 8, 2006
(86) PCT No.: PCT/GB2006/000442

§ 371 Date: Apr. 28, 2008

(30) Foreign Application Priority Data
Mar. 9, 2005 (GB) 0504846.7

(51) Int. Cl. H01P 1/06

(52) U.S. Cl. 333/261

(57) ABSTRACT

A rotary coupler comprises a stator 1 having a first face 3a and a rotor 2 having a second face 4a, the first and second faces 3a, 4a being spaced apart from and facing each other. A first electrically conducting track 5 is provided on the first face 3a of the stator 1 which forms a transmission line and has spaced apart ends A, B and a second electrically conducting track 6 is provided on the second surface 4a of the rotor 2 also forming a transmission line and having spaced apart ends C, D. One end A of the first track 5, in use, is connected to signal generating means and the other end B of said first track IS connected to earth through a resistor substantially equal to the characteristic impedance of the transmission line. The first track 5 extends along a generally circular arc substantially around the first face 3a of the stator 1, said first track 5 having a length substantially equal to an integer number of wavelengths of the signal produced, in use, by the signal generating means. The second track (6) extends along a generally circular arc partially around said second face 4a of the rotor 2, said second track 6 having a length substantially equal to one quarter of the wavelength of the signal produced, in use, by said signal generating means.

The present invention relates to RF rotary couplers and in particular to couplers which electrically couple a passive RF sensor based on resonators or delay lines on a rotating shaft to stationary interrogation electronics in a wireless or mechanically non contacting manner.

WO96/37921 and GB 2 328 086 have described systems in which coupled microstrip lines are used to connect to a sensor wirelessly. In particular, they use two circular coupled transmission lines of nominally equal circumference so that intrinsically the amount of coupling will always vary with rotation. These systems have the drawback, however, that they are not very effective for microstrips significantly larger than ¼ λ, where λ is the wavelength of the transmitted signal.

Another systems is described in GB 2 368 470 which allows for 360° coupling between microstrip lines for diameters above ¼ λ. These systems work by connecting together multiple sections of ¼ λ coupled microstrips together and spreading these lines around a larger diameter. These systems suffer from the fact that the larger the diameter the more ¼ λ elements that are needed and the feeding networks can then become quite cumbersome. They also suffer from the same problem as the aforementioned systems in that the amount of coupling will intrinsically vary with rotation.

According to the present invention there is provided a rotary coupler comprising a stator having a first surface and a rotor having a second surface, said first and second surfaces being spaced apart from and facing each other, a first electrically conducting track provided on said first surface of said stator forming a transmission line and having spaced apart ends and a second electrically conducting track provided on said second surface of said rotor also forming a transmission line and having spaced apart ends, one end of said first track, in use, being connected to signal generating means and the other end of said first track being connected to earth through a resistor equal to the characteristic impedance of the transmission line, said first track extending along a generally circular arc substantially around said first face of the stator, said first track having a length substantially equal to an integer number of wavelengths of the signal produced, in use, by said signal generating means, and said second track extending along a generally circular arc partially around said second face of the rotor, said second track having a length which is smaller than the length of the first track.

Above and hereinafter, the term generally circular arc is used to cover both a path which extends along a smooth circular arc, having a length equal to the length of the arc, as well as a path which undulates but whose average path or average radius defines a substantially circular arc, whereby the actually length of the path is greater than the length of the average circular arc defined by the path.

A coupler in accordance with the invention has the advantage that there is no discontinuity in the field distribution in the stator transmission line and as a result there is no angular variation of the resonant frequency (or differential phase delay) of the sensor connected to the rotor output and measured at the stator input.

For optimum coupling, the length of the second track is substantially equal to one quarter of the wavelength of the signal produced, in use, by said signal generating means. The second track may, however, also be implemented with a length other than one quarter of the wavelength of the signal produced, in use, by said signal generating means depending upon the desired output impedance of the rotor.

Preferably, each of the rotor and the stator are formed of a substrate having a conducting back which forms a ground plane for the track disposed thereon. More particularly, one end of the track on the rotor is preferably connected to said ground plane, either directly or in directly. A sensor is then preferably connected between one end of the rotor track and earth, and the other end of the rotor track is then either shorted directly to ground, in which case for optimum coupling the second track should have a length substantially equal to one quarter of the wavelength of the signal produced, in use, by the signal generating means, or connected to a capacitor which is grounded, in which case the second track advantageously has a length which is less than one quarter of the wavelength of the signal produced by the signal generating means in order to achieve optimum coupling. Optionally, an inductor could be connected in parallel with the sensor connected to the one end of the rotor track.

Preferably, the rotor track extends along a substantially smooth circular arc which is concentric with the shaft on which, in use the rotor is mounted. In one embodiment, the stator track similarly extends along a substantially smooth circular arc, through slightly less than 360 degrees. In applications in which an integer number of wavelength is larger than the circumference of the arc, however, the stator track extends around the face in an undulating fashion, extending back and forth across a circular arc which defines the average path thereof. For example, the track might zig-zag around said face or travel in a more irregular fashion, in either event, the actual length of the track being longer than the length of the circular arc defining the average path.

In one embodiment, the rotor and stator are each formed by an annular disc mounted concentrically onto the shaft, the rotor and stator being axially separated from each other and the first and second faces being formed by facing axial annular faces of the stator and rotor.

Alternatively, the rotor and stator may each be formed as a cylindrical member, the rotor being concentrically positioned with the stator and having an outer diameter which is slightly smaller than the inner diameter of the stator so as to define a space therebetween. The first and second faces will then be formed by the inner cylindrical surface of the stator and the outer cylindrical surface of the rotor respectively, the tracks extending around said respective surface along a circular arc, or generally along a circular arc, centred on the centre of the shaft. Any undulation or meandering in the stator track will then be in the axial direction.

Preferably, the circular arc defining the path of the rotor and stator tracks have substantially the same radii, although in the case of the cylindrical rotor and stator, the radius of curvature of the stator track will necessarily be slightly larger than that of the rotor track.

Multiple rotor tracks may optionally be provided, isolated from each other. Multiple sensors may also optionally be connected to the or each rotor track, either in series or parallel.

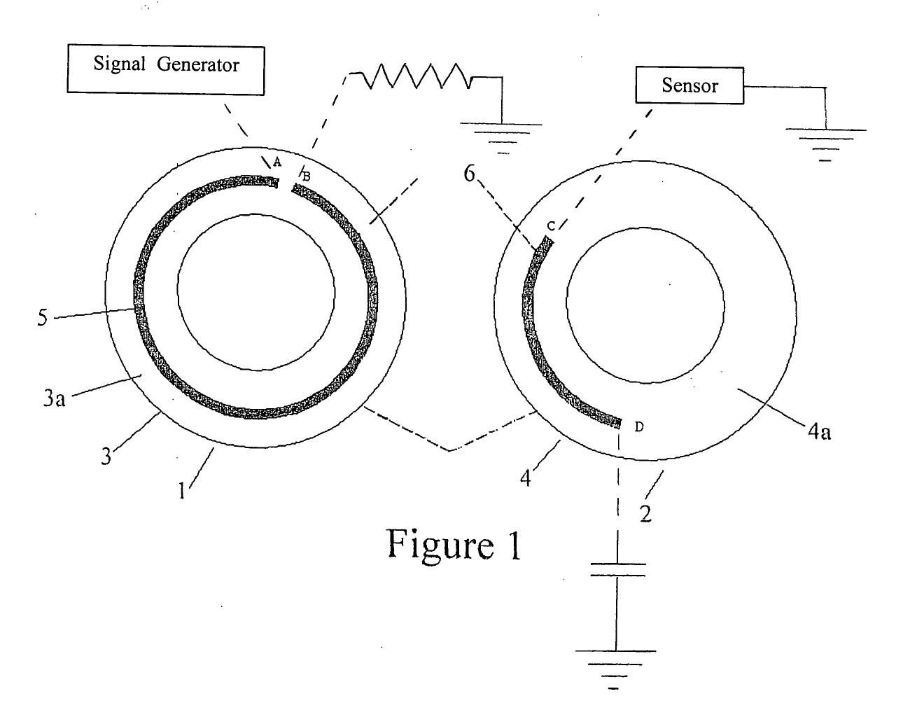

The coupler is based upon two mechanically separate microstrips of differing lengths. The microstrip on the stator assembly is circular and has an electrical length which is nominally a wavelength (λ) long (or integer multiply there of). The rotor microstrip is an arc of nominally the same radius as the stator but with an electrical length of preferably approximately ¼ λ or less. The stator microstrip should be terminated in a load that is similar to the characteristic impedance of the line whilst the rotor can be any. FIG. 1 shows an example of one configuration.

The two halves of the coupler shown in FIG. 1 would be positioned over a rotating shaft so that the two microstrips face each other but spaced apart so no direct mechanical contact is made. The signal is fed into the stator microstrip between terminal ‘A’ and the ground plane on the back of the substrate. Terminal ‘B’ is also to be connected to the ground plane via a resistor approximately equal to the characteristic impedance of the line. On the rotor the sensor is connected between terminal ‘C’ and the ground plane and terminal ‘D’ shorted directly to the ground plane of the substrate. The design shown has the microstrips on two planar surfaces, they could however be coaxial to each other and the shaft.

In order that the invention may be well understood, there will now be described some embodiments thereof, given by way of example, reference being made to the accompanying drawings, in which:

FIG. 1 is a schematic illustration of a rotary coupler according to a first embodiment of the invention;

Referring first to FIG. 1, there are shown two halves of a rotary coupler according to the invention comprising a stator 1 and a rotor 2. In the illustrated axial embodiment, the rotor 2 and stator 1 are formed by annular discs 3, 4 which, in use, would be positioned over a rotating shaft (not shown) with annular faces 3a, 4a directed towards each other and spaced apart from each other so that no direct mechanical contact is made therebetween.

The facing annular faces 3a, 4a of the stator and rotor discs 3, 4 each have an electrically conducting microstrip 5, 6 provided thereon which operate as antennas for respectively transmitting and receiving a signal. The microstrip 5 on the stator is defined by a substantially circular arc which is concentric with the stator disc 3, extends substantially around the face 3a of the stator disc 3 although with its ends A, B separated from each other and has an electrical length which is substantially equal to λ, the wavelength of the signal which is to be transmitted by the stator, thereby minimising the discontinuity in the field above the terminals ‘A’ and ‘B’. If the track length is equal exactly 1 λ and the line is loss less then the instantaneous signal seen at terminal ‘A’ will equal that in phase and magnitude of the one seen at ‘B’. The importance of this is so that the coupling to the rotor microstrip will remain constant with rotation. The only property of the signal to change will be the phase as the effective path length of the signal changes with rotation.

The signal is fed from a circuit into the stator microstrip 5 between terminal ‘A’ and the ground plane formed by the substrate forming the body of the stator disc 3. Terminal ‘B’ is connected to the ground plane via a resistor the value of which is substantially equal to the characteristic impedance of the circuit feeding the signal to the stator microstrip 5.

The microstrip 6 on the rotor is formed as a circular arc which extends only partially around the shaft on which, in use, the rotor is mounted between terminals ‘C’ and ‘D’ and has a length equal to λ/4, one quarter of the wavelength of the signal fed to the stator. The main body of the rotor disc 4 again forms a ground plane for the microstrip 6 with a sensor connected between the terminal ‘C’ and said ground plane for detecting the signal transmitted by from the stator, and the terminal ‘D’ being shorted directly to the ground plane. It will, or course, be understood that the end chosen to have a particular connection as described above is arbitrary and may be interchanged, i.e. terminal C may be shorted to ground and the sensor connected between terminal D and ground.

In the embodiment of FIG. 1, the radius of the arc of the rotor and stator microstrips are the same, although they do not need to be exactly so. Furthermore, instead of directly shorting terminal ‘D’ to ground, a capacitor could be connected between ‘D’ and the ground plane which would allow for tuning of the effective length of this line. In this case, the length of the microstrip 6 on the rotor should be reduced to less than λ/4 for optimum coupling. Furthermore, an inductor could be placed in parallel to the sensor at terminal ‘C’ so as to allow the magnitude of the reflected signal from the sensor to be optimised.

In a further modification of the system of FIG. 1, multiple sensors could be provided on the rotor microstrip, connected to terminal ‘C’ either in series or in parallel. It would also be possible to provide multiple microstrips on the rotor, each of length λ/4, and each having a sensor electrically connected to its ‘C’ terminal, each said microstrip being interrogated through the same stator microstrip. In a still further modification, multiple microstrips could be provided on the stator having different lengths and operable with signals of different wavelengths, each stator strip then being tuned to a corresponding rotor strip by appropriate fixing of the lengths thereof.

Preferably, the length of the stator strip is slightly different to λ or the stator load resistance slightly differs from characteristic impedance such that an amplitude variation with rotation arises. In this way, it is possible to measure the angle or speed of rotation.

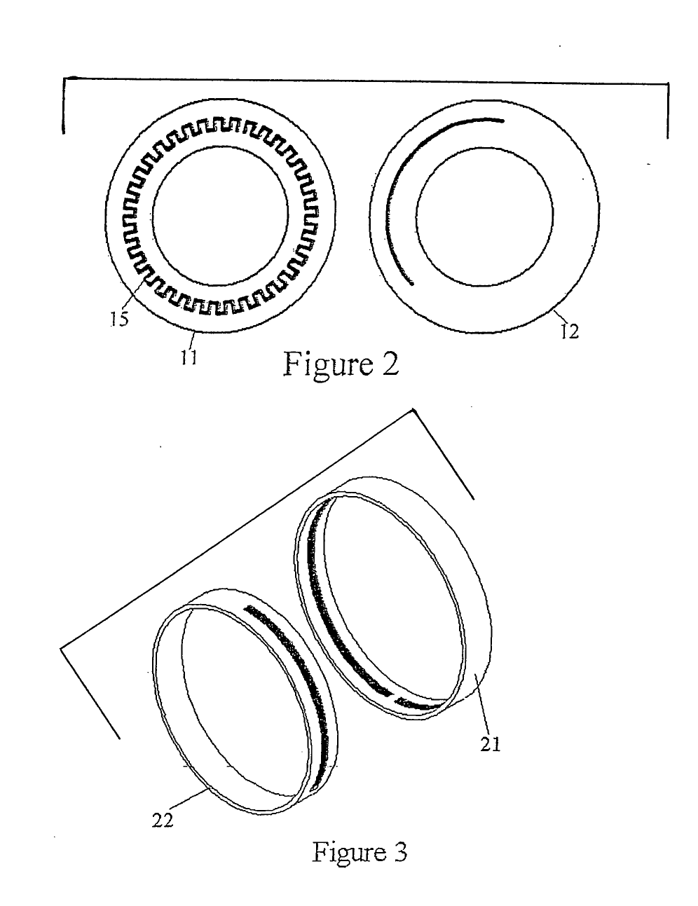

In the embodiment of FIG. 1, the fact that the stator microstrip needs to be of length λ imposes a constraint on the mechanical design of the system as for a given dielectric it fixes the diameter of the coupler. This drawback is overcome in an alternative embodiment illustrated in FIG. 2, by configuring the stator strip 15 to extend along a path which is still generally circular but which undulates away from the average radius so as to increase the length of the track. This can be achieved, for example, by having the track zig-zag in the radial direction either side of the average radius, or by following an irregular undulating path. As clearly shown in FIG. 2, the rotor microstrip still follows a smooth circular arc equal to substantially λ/4 and having a radius substantially equal to the average radius of the generally circular path defined by the stator track. In this way, it is possible to package a stator track having the same electrical length in a smaller average diameter.

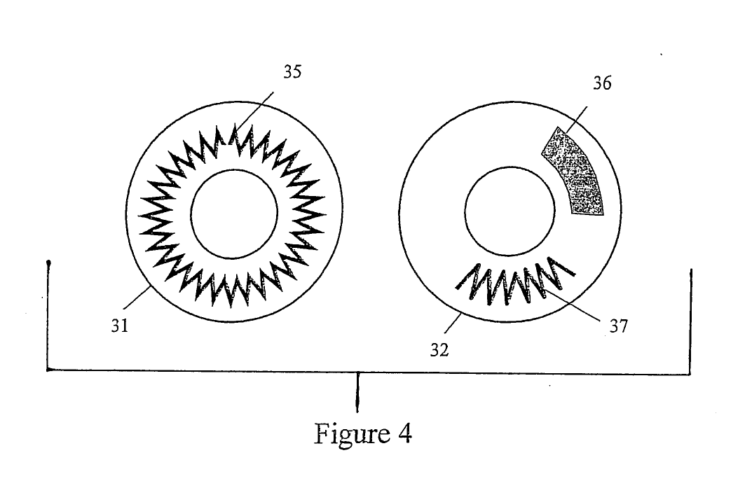

In a further development of the embodiment of FIG. 2, illustrated in FIG. 4, the rotor strip 36 on the rotor 32 is modified to encompass a radial width which is substantially equal to the radial distance between the maximum and minimum radial positions of the undulating stator strip 35 provided on the stator 31—i.e. the effective width of the rotor strip 36 is substantially equal to the effective width of the stator strip 35 provided on the stator 31. The length of the rotor strip is then preferably less than or equal to λ/4. In this system, the rotor strip may be formed by an arcuate band track, the length of the average arcuate path then preferably being less than or equal to λ/4.

FIG. 3 illustrates a further embodiment in which the rotor 22 and stator 21 are cylindrically shaped and concentrically arranged with the rotor 22 inside the stator 21 so as to have co-operating inner and outer cylindrical surfaces facing each other and spaced apart so as not to be in contact. Microstrips 25,26 are then provided on the facing surfaces so as to extend circumferentially around the inner and outer cylindrical surfaces, the stator strip 25 having a length substantially equal to λ and the rotor strip 26 substantially equal to λ/4. The stator strip 25 extends along a general circular path with its ends spaced apart as in the previous embodiment, and may be configured in an undulating path, said undulations extending axially from the average path, in order to increase the electrical length without increasing the radius of the stator cylinder.

1-21. (canceled)

22. A rotary coupler having a stator surface and a rotor surface that is spaced apart from and facing the stator surface comprising:
a stator comprising a stator surface and a first electrically conducting track disposed on said stator surface forming a transmission line and having a first end and a spaced second end, said first track extending along a generally circular arc substantially around said stator surface; and
a rotor comprising a rotor surface and a second electrically conducting track disposed on said rotor surface forming a transmission line and having a first end and a spaced second end, said second track extending along a generally circular arc partially around said rotor surface, said second track having a length which is less than the length of the first track;
wherein the first end of said first track is configured to be connected between signal generating means and ground through a resistor having a resistance substantially equal to the characteristic impedance of the transmission line formed by the first track;
wherein said first track has a length substantially equal to an integer number of wavelengths of a signal produced by said signal generating means; and
wherein the first end of said second track is configured to be connected to ground through a sensor.

23. A rotary coupler according to claim 22, wherein length of the second track is less than or substantially equal to one quarter of the wavelength of the signal produced, in use, by said signal generating means.

24. A rotary coupler according to claim 22, wherein each of the stator and the rotor is formed of a substrate having a conducting back which forms a grounding plane for the track disposed thereon.

25. A rotary coupler according to claim 22, wherein the second end of the second track is connected directly to ground, the second track preferably having a length substantially equal to one quarter of the wavelength of the signal produced, in use, by said signal generating means.

26. A rotary coupler according to claim 22, wherein the second end of the second track is connected to ground through a capacitor, the second track preferably having a length substantially equal to one quarter of the wavelength of the signal produced, in use, by said signal generating means.

27. A rotary coupler according to claim 22, wherein the first track extends along a circular arc which is just less than 360 degrees.

28. A rotary coupler according to claim 22, wherein the stator is mounted on a shaft and the first track extends along a substantially smooth circular arc concentric with the shaft.

29. A rotary coupler according to claim 22, wherein the first track extends along an undulating path across the first surface, which repeatedly crosses a circular arc which defines the average path of the first track.

30. A rotary coupler according to claim 22, wherein the rotor is mounted on a shaft and the second track extends along a substantially smooth circular arc which is concentric with the shaft.

31. A rotary coupler according to claim 22, wherein the second track extends along an undulating path across the second surface, which repeatedly crosses a circular arc which defines the average path of the first track.

32. A rotary coupler according to claim 31, wherein the second track comprises a base circular arc having a plurality of circumferentially spaced radial tracks extending therefrom.

33. A rotary coupler according to claim 32, wherein the effective radial width of the first track is substantially equal to the effective radial width of the second track.

34. A rotary coupler according to claim 22, wherein the stator and the rotor are formed by a pair of annular discs which are concentrically mounted on a shaft and are axially spaced apart from each other, said first and second surfaces being formed by facing axial annular faces of said discs.

35. A rotary coupler according to claim 22, wherein the stator and rotor are each formed as a cylindrical member, said first and second tracks being disposed on respective cylindrical surfaces of the stator and rotor.

36. A rotary coupler according to claim 35, wherein the rotor is positioned concentrically within and axially aligned with the stator, the rotor having an outer diameter which is slightly smaller than the inner diameter of the stator such that the first and second tracks are radially spaced apart.

37. A rotary coupler according to claim 36, wherein the first track is provided on the inner cylindrical surface of the stator and the second track is provided on the outer cylindrical surface of the rotor.

38. A rotary coupler according to claim 22, wherein the stator and rotor are each formed as a cylindrical member, said first and second tracks being provided on respective cylindrical surfaces of the stator and rotor, said first track undulating across said first surface in an axial direction.

39. A rotary coupler according to claim 22, wherein the rotor is mounted on a shaft and the second track extends along a substantially smooth circular arc concentric with the shaft.

40. A rotary coupler according to claim 22, wherein a plurality of tracks are provided on the second surface of the rotor, each of the tracks on the rotor being isolated from the other tracks on the rotor.

41. A rotary coupler according to claim 22, wherein multiple sensors are connected to each track provided on the rotor.
